(19) United States
(12) Patent Application Publication
(10) Pub. No.: US 2019/0308531 A1
(43) Pub. Date: Oct. 10, 2019

(54) Wheeled Child Safety Seat

(71) Applicants: Max Liu, Solon, OH (US); Xin Jiang, Solon, OH (US)

(72) Inventors: Max Liu, Solon, OH (US); Xin Jiang, Solon, OH (US)

(21) Appl. No.: 15/945,703

(22) Filed: Apr. 4, 2018

(51) Int. Cl. B60N 2/28; B60N 2/90

(52) U.S. Cl. CPC B60N 2/2848; B60N 2/995; B60N 2/2845

(57) ABSTRACT

A safety seat (100) includes a seat body (10) and a set of caster wheels (11). The safety seat can ride on the caster wheels (11). The safety seat can also include a handle (12) for easy manipulation and a footrest (13) for the child to rest the feet. The caster wheels (11), the handle (12) and the footrest (13) can be retracted when they are not used and extended out when needed.

The present application relates to a wheeled child safety seat. It finds particular application to child safety seats or baby safety seats that are required to transport a child on a family vehicle.

Child safety seats are usually used to provide safety and comfort for children when they ride in a family vehicle. There are various features in modern child safety seat to provide safety and comfort for the child to sit in while riding a family vehicle. While transporting a child outside a vehicle, for example transporting from one terminal to another terminal at an airport or visiting a place during vacation, child safety seat provide little help for transporting the child. A stroller can be used to transport a child if a stroller is available. However, stroller may not always be available, especially when travelling with a child away from home, for example people might bring a safety seat but not a stroller when fly away from home for family vacation.

The present application proposes to address these problems with a wheeled safety seat design. For child's safety and comfort, and/or due to requirement by law, child safety seat is available when traveling with a family vehicle or a rental vehicle. The present application enable the safety seat to be used into a wheeled configuration that can be used to aid the transportation of child outside a vehicle.

A wheeled safety seat is disclosed which comprises a set of caster wheels that mounts on the safety seat and for the safety seat to ride on. The wheels could be extended for the safety seat to ride on. The wheels could also be retracted when desired, such as when the safety seat is used in a vehicle.

A handle could be mounted on the safety seat for easy manipulation of the wheeled safety seat when it is used outside a vehicle. A footrest could also be mounted in the safety seat for the child's feet to rest on. The handle and the footrest could be extended out when needed and they could be retracted when desired, such as when the safety seat is used in a vehicle.

One advantage resides in using the safety seat to transport a child outside a vehicle easily since the safety seat with a child sits in can ride on wheels.

Another advantage resides in easier manipulation of the safety seat by holding on the handle.

Another advantage resides in improved child comfort since the child's feet can rest on the footrest.

Another advantage resides in space saving since the caster wheels, the handle and the footrest could be retracted when they are not in use.

Still further advantages of the present invention will be appreciated to those of ordinary skill in the art upon reading and understanding the following

### DETAILED DESCRIPTION

The invention may take form in various components and arrangements of components, and in various steps and arrangements of steps. The drawings are only for purposes of illustrating the preferred embodiments and are not to be construed as limiting the invention.

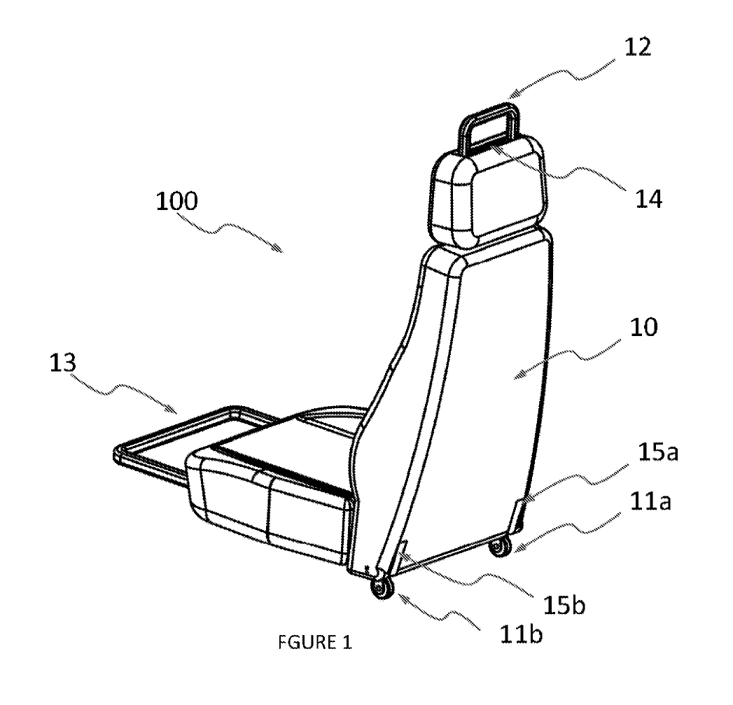

FIG. 1 illustrates a wheeled safety seat, with the caster wheels, the handle and the footrest extended.

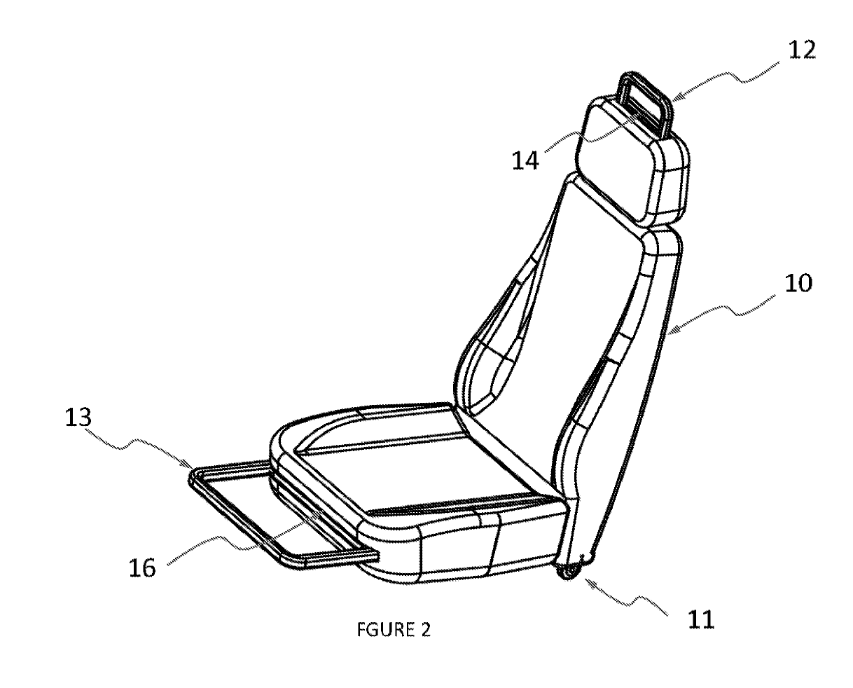

FIG. 2 illustrates the same safety seat shown in FIG. 1 from a different view angle.

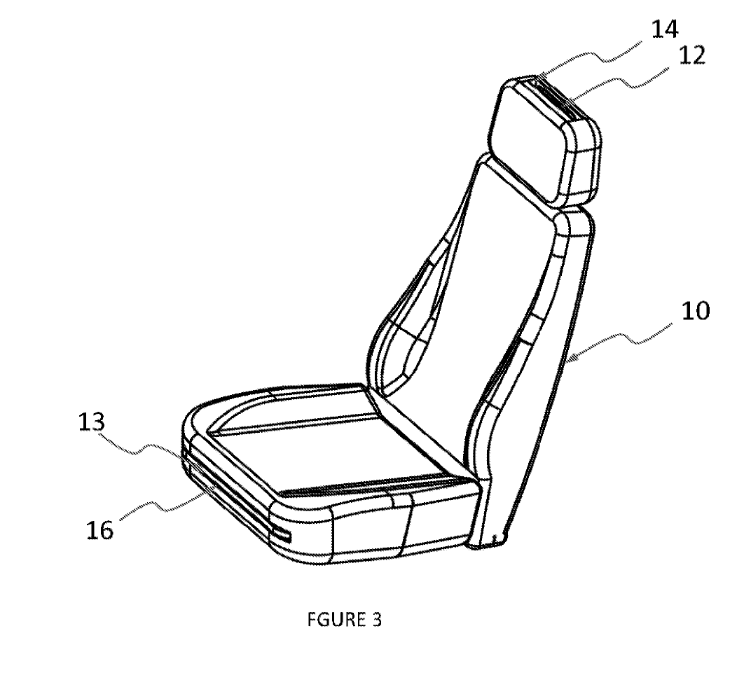

FIG. 3 illustrates wheeled safety seat with the caster wheels, the handle and the footrest retracted.

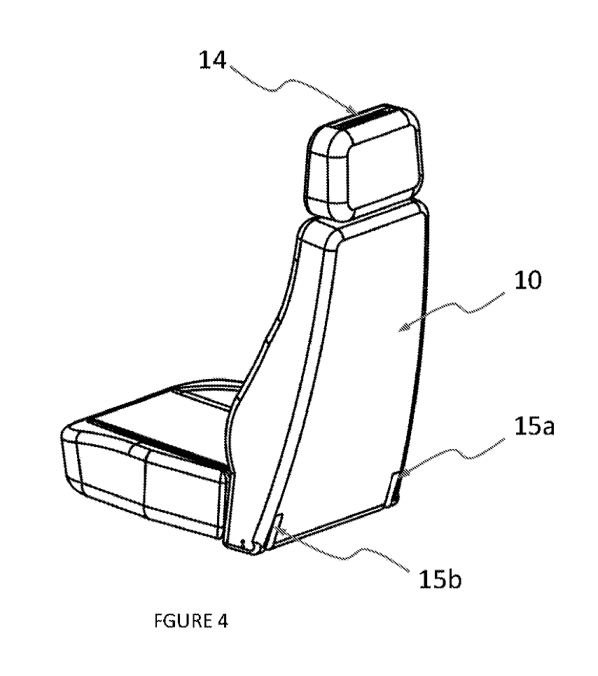

FIG. 4 illustrates the same safety seat shown in FIG. 3 from a different view angle.

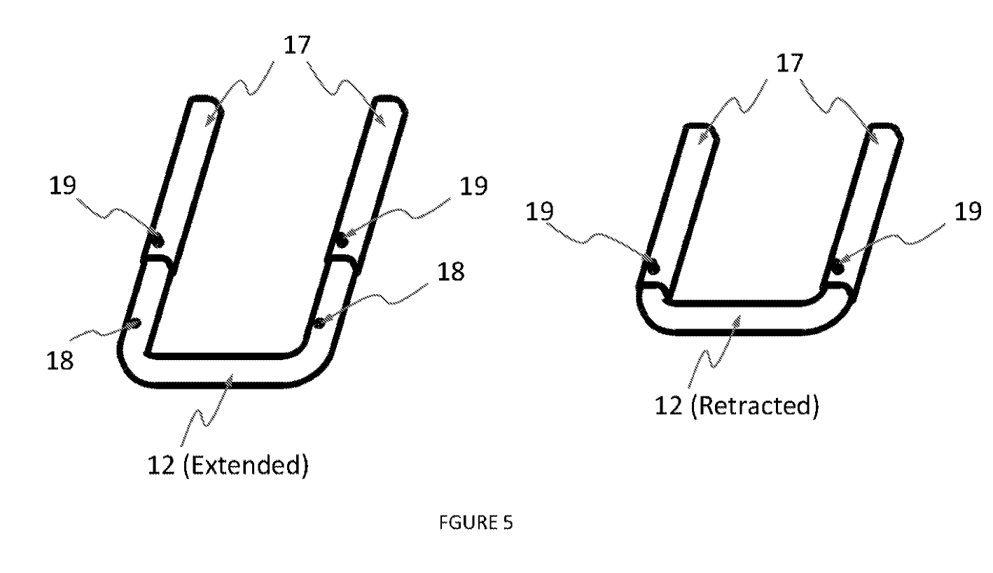

FIGS. 5 illustrates one embodiment that can be used to realize the handle and the footrest retraction.

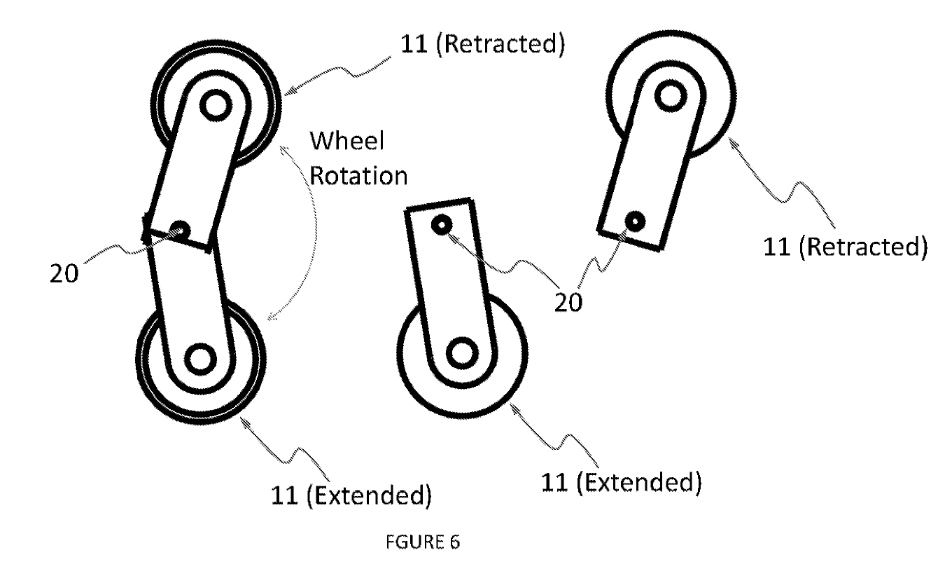

FIG. 6 illustrates an embodiment that can be used to realize the caster wheel retraction.

With reference to FIG. 1, a wheeled safety seat 100 has a seat body 10. In this shown orientation, bottom is the down orientation of FIG. 1 and front is the left of FIG. 1. Caster wheels 11 are mounted at the bottom of the seat body 10. Two caster wheels, labelled 11a and 11b are shown. It is also possible to mount more than 2 caster wheels. A handle 12 is mounted at or close to the top of seat body 10. A footrest 13 is mounted close to the bottom front of the safety seat, where the child can rest his/her feet. There are slots on the seat body 10 to hold the caster wheels 11, the handle 12 and the footrest 13 when they need to be retracted. Slot 14 is for handle 12. Slots 15 are for the caster wheels 11. Two caster wheel slots embodiments are shown in FIG. 1, labelled as 15a and 15b.

FIG. 2 shows the same safety seat shown in FIG. 1, but from a different view angle. The safety seat body 10, the handle 12, and the footrest 13 are clearly shown from a different perspective. Slot 14 that is for handle 12 and slot 16 that is for footrest 13 are shown in FIG. 2.

With reference to FIG. 3, a retracted configuration of the safety seat is shown. The caster wheels 11, the handle 12, and the footrest 13 that are extended as shown in FIG. 1 and FIG. 2 are shown in FIG. 3 in their retracted positions. At their retracted positions, the caster wheels 11, the handle 12, and the footrest 13 may not be visible. The slot 14 to hold the retracted handle 12 and the slot 16 for the footrest 13 are visible.

FIG. 4 shows the same safety seat shown in FIG. 3, but from a different view angle. The caster wheels 11, the handle 12 and the footrest 13 are not visible. The slot 14 for the retracted handle 12 and the slots 15 (15a and 15b) for the caster wheels 11 are visible.

With reference to FIG. 5, an embodiment of the handle retraction mechanism is shown. Two sleeves 17 are mounted on the seat body 10 (not shown). Handle 12 is inserted into the sleeves 17 and can slide along the sleeves 17. Sliding handle 12 out relative to sleeves 17 will move handle 12 to extended position. Sliding handle 12 in will move handle 12 to retracted position. There are holes 18 cut in handle 12 and holes cut in sleeves 17. Pins 19 can be inserted thru the holes 18 on the handle 12 and the holes on the sleeves 17 to hold the handle 12 at the retraced position or at the extended position. Pins 19 can be pulled out of the way when moving handle 12 inside sleeves 17.

FIG. 6 illustrates an embodiment that can be used to realize the caster wheel 11 retraction and extension. In FIG. 6, caster wheel 11 is shown at the retracted position (right), extended position (middle) and overlapped illustration of retracted and extended positions (left). Caster wheel 11 can be rotated around Pin 20 between the extended position and the retracted position.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. A safety seat (100) comprising a seat body (10) and a set of caster wheels (11) so that the safety seat can ride on the caster wheels (11).

2. The safety seat according to claim 1 wherein the safety seat includes a handle (12) at the top of the seat body (10).

3. The safety seat according to claim 2 wherein the safety seat includes a footrest (13) at the front bottom of the seat body.

4. The safety seat according to any one of claims 1-3 wherein the caster wheels (11), the handle (12) and/or the footrest (13) can be extended out or retracted in.
